(19) United States
(12) Patent Application Publication
(10) Pub. No.: US 2014/0370611 A1
(43) Pub. Date: Dec. 18, 2014

(54) PROCESS FOR DETERMINING THE REACTION MECHANISM OF A REACTION AND ASSOCIATED DEVICE

(71) Applicants: CENTRE NATIONAL DE LA RECHERCHE SCIENTIFIQUE (C.N.R.S), Paris (FR); UNIVERSITE PIERRE ET MARIE CURIE (PARIS 6), Paris (FR); ECOLE NORMALE SUPERIEURE, Paris Cedex 5 (FR)

(72) Inventors: Charlie Gosse, Paris (FR); Annie Lemarchand, Villemoisson-Sur-Orge (FR); Ludovic Jullien, Arcueil (FR); Thomas Le Saux, Paris (FR); Kais Zrelli, Paris (FR)

(21) Appl. No.: 14/362,707

(22) PCT Filed: Dec. 6, 2012
(86) PCT No.: PCT/EP2012/074699

§ 371 Date: Jun. 4, 2014

(30) Foreign Application Priority Data
Dec. 7, 2011 (FR) 1161290

(51) Int. Cl. G06F 19/00

(52) U.S. Cl. CPC G06F 19/702; G06F 19/701
USPC 436/86; 436/94; 422/68.1; 702/22

(57) ABSTRACT

The method according to the invention includes choosing a reaction presumed reaction mechanism; selecting, for said mechanism, at least one first function characteristic of a thermokinetic property that is invariant with the periodic variation frequency of a control parameter influencing said reaction, the first characteristic function being calculated at least from first-order oscillation amplitudes of the concentration of at least one of the species involved in said reaction. The method includes calculating a plurality of values of the first characteristic function from first-order oscillation amplitudes obtained experimentally and analyzing the calculated values of the first characteristic function to determine whether the first characteristic function is constant based on the calculated values, and if the first characteristic function is constant, assigning the presumed mechanism to said reaction.

The present invention relates to a method for determining the reaction mechanism of a reaction, in which at least one first reagent is transformed into at least one first product, the process including the following steps:

(a1)) carrying out a reaction to transform the first reagent into a first product under given experimental conditions, the reaction comprising the periodic variation at a given frequency of a control parameter influencing the reaction;

(a2) scanning a plurality of given frequencies of periodic variations of the control parameter influencing the reaction;

(a3) for each studied frequency, measuring a property representative of the concentration of at least one of the species under the effect of the periodic variation, to determine at least the first-order oscillation amplitudes of the concentration.

Such a process in particular applies to the determination of the chemical reaction mechanism between reagents, in order to obtain characteristic thermokinetic properties of the reaction.

Proper knowledge of the reaction mechanism makes it possible to optimize the conditions under which a reaction is to be conducted at the laboratory scale or the industrial scale. This for example makes it possible to select the reagents and the reaction conditions to increase the production speed of a product or to obtain an improved output. This also makes it possible to optimize the reaction speed between molecules with a view to making a therapeutic treatment more effective or a detection method more sensitive.

Alternatively, this knowledge also makes it possible to select or screen molecules having a certain activity or capable of bonding to other molecules, or active sites on surfaces, in order for example to determine the therapeutic applications of those molecules or catalytic applications of those molecules or surfaces. This knowledge also enriches the chemical reaction models that are used to understand the world around us.

Determining the reaction mechanism of a reaction is generally a difficult operation. It requires the use of complicated experimental techniques and theoretical and practical study protocols that may be time-consuming and costly in terms of reagents.

In general, the interaction between two chemical species A and B is characterized by a collection of elementary actions. Most often, it is possible to reduce that collection to a limited number of reactions that provide a satisfactory report on the dynamics of a mixture of A and B at a given timescale. A reaction mechanism is then obtained.

Modeling using a unique process of type:

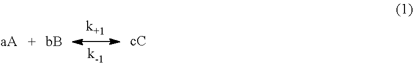

is a situation commonly encountered in chemistry and biology. The interaction between A and B is then primarily characterized by a stoichiometry (given by the coefficients a, b and c), by critical constants k₊₁ and k₋₁ and by a thermodynamic constant K₁. To these last three constants, it is possible to add the activation energies E±₁ as well as the reaction enthalpy Δ₁H=E₊₁−E₋₁, the whole forming a set of thermokinetic constants associated with the considered reaction.

However, A and B can interact according to various mechanisms (for example, simple mechanisms of type A+B=C, or more complex mechanisms of type 2A+B=C, A+B=2C, A+B+C=2C, etc.) that are sometimes more difficult to discriminate.

In order to determine kinetic constants, measuring apparatuses are known in which the reagents are mixed and a measurement of the progression of the reaction over time is done.

A first type of known apparatus, of the “stopped flow” type, works in homogenous phase. Various solutions containing the reagents are brought through a system of channels and fluid elements and the mixture formed is collected in a dish, in which different properties are measured using measuring devices.

Such apparatuses are not fully satisfactory. Indeed, they require significant volumes of reagents, which are not always available, in particular in the case of molecules available in small quantities or that are very expensive. Attempts have been made at miniaturization, but then it is a matter of managing the mixture at a low Reynolds number, which becomes problematic. Additionally, it is not possible to use such devices when the reaction medium is not fluid, for example when the reactions form a gel or a solid.

Furthermore, the fluid movements necessary to implement this technique may disrupt the reaction, in particular for complex and fragile reaction mediums, for example those containing biological objects.

A second type of known apparatus, of the surface plasmon resonance (SPR) type, works in heterogeneous phase. One of the reagents is immobilized on the surface and a solution containing the other reagent is injected into the fluid chamber. The progression of the reaction is monitored continuously.

Due to molecule/surface interactions, such an apparatus does not, however, reflect the actual conditions encountered when the reaction takes place in a homogenous phase, which is the situation most traditionally encountered.

Furthermore, a third type of apparatus, of the “T-jump” type, also exists to perform kinetic measurements, by performing a temperature jump and determining the response of a system to such a temperature jump. This type of apparatus takes a measurement that is not stationary and therefore generally requires a significant disruption of the system so as to be able to monitor the modification of the progression of the reaction with a sufficient resolution, which can then make modeling phenomena delicate. Furthermore, it is generally necessary to work with a significant quantity of reagents.

A fourth type of apparatus produces a periodic variation of an experimental control parameter influencing the reaction kinetics, then measures a property representative of the concentration of a reagent at different frequencies. This type of apparatus is not commercially available.

Thus, the article “Lock-in by molecular multiplication” by Braun et al., Appl. Phys. Lett., 83, pages 5554 to 5556 (2003), describes a method for determining chemical relaxation times (τ=1/(k₊₁+k₋₁) in the present case). The control parameter influencing the reaction is the temperature in that case. The experimental data relative to the reagent concentrations obtained with different delays relative to the thermal excitation make it possible to measure the amplitude and phase of the response of the chemical system, then to establish the corresponding Bode diagrams. The relaxation time is then determined from these diagrams by digital adjustment.

To calculate the kinetic constants, irrespective of the technique used, it is generally known to assign a given mechanism to a reaction, then to determine the kinetic constants based on the assigned mechanism. This is in particular true for the fourth type of apparatus and the demonstration done by Braun et al.

One aim of the invention is to obtain a method that reliably and precisely makes it possible to obtain a determination of the mechanism and the thermokinetic parameters of a chemical reaction involving at least one reagent reacting to form a produced species.

To that end, the invention relates to a method of the aforementioned type, characterized in that the method further includes the following steps:

(a4) choosing a reaction presumed reaction mechanism;

(a5) selecting at least one first function characteristic of a thermokinetic property that is invariant with the oscillation frequency for said supposed reaction mechanism, the first characteristic function being calculated at least from first-order oscillation amplitudes of the concentration of at least said species;

(a6) calculating a plurality of values of the first characteristic function from first-order oscillation amplitudes obtained experimentally for the plurality of frequencies of the periodic excitation described in the step (a2);

(a7) analyzing the calculated values of the first characteristic function to determine whether the first characteristic function is constant based on the calculated values;

(a8) when the first characteristic function is constant, assigning the presumed mechanism to said reaction.

The method according to the invention may comprise one or more of the following features, considered alone or according to any technically possible combination:
the control parameter influencing the reaction is the temperature, step (a1) including the periodic variation of the temperature at the given frequency, step (a2) including the scanning of a plurality of temperature variation frequencies;
for each frequency, it includes determining second-order oscillation amplitudes of the concentration in at least one of the species, the first characteristic function selected in step (a5) being calculated based on first-order oscillation amplitudes, and based on second-order oscillation amplitudes;
the first characteristic function is calculated based on a reduced form of the ratio of the activation energies to the perfect gas constant multiplied by the mean temperature of the sample;
it includes selecting at least one second characteristic function of a second thermokinetic property that is invariant with the oscillation frequency for said presumed mechanism, the second characteristic function being calculated from at least the first-order oscillation amplitudes of the concentration of at least said species, the method including determining a plurality of values of said second characteristic function from first-order oscillation amplitude measurements obtained in step (a3) for a plurality of frequencies of the periodic excitation and the analysis of calculated values of the second characteristic function to determine whether the second characteristic function is constant;
the second characteristic function is calculated based on the relaxation time of the presumed reaction mechanism;
the second characteristic function is calculated on the basis of the reaction enthalpy of the presumed reaction mechanism;

it includes selecting a non-constant secondary characteristic function for the presumed reaction mechanism, the secondary characteristic function having a constant sign irrespective of the oscillation frequency for the presumed reaction mechanism, the method including the determination of a plurality of values of the secondary characteristic function from first-order oscillation amplitude measurements obtained in step (a3), and analyzing the sign of those values to determine whether the sign is constant;
the first characteristic function is expressed on the basis of at least one parameter chosen from among the stationary term A⁰ of the concentration variations in a species A, the coefficients A^{1 sin}, A^{1 cos}, and option ally the coefficients A^{2 sin}, A^{2 cos} that correspond to the first-order and second-order oscillation amplitudes, respectively, of the concentration of that species A, the pulseω, and/or the value N of the concentration of that species A before the beginning of the reaction;
the presumed mechanism is chosen from among a mechanism of type A+B=C; A+B=2 C; 2A+B=C; A+B+C=2C; A+B=C=D=A+B;
it includes a step for calculating at least one thermokinetic constant, based on equations representative of that constant for the mechanism assigned in step (a8), the representative equations depending at least on the measured first-order amplitudes;
when the first characteristic function is not constant in step (a7), the method includes the choice of another reaction presumed reaction mechanism and the repetition of steps (a5) to (a8) for the other presumed reaction mechanism.

The invention also relates to a device for determining the reaction mechanism of a reaction in which at least one first reagent is transformed into at least one first product, including:
an assembly for carrying out a reaction to transform the first reagent into a first product under given experimental conditions, the carrying out assembly comprising a unit for periodic variation of a control parameter influencing the reaction at a given frequency;
means for scanning a plurality of given frequencies of periodic variations of the control parameter influencing the reaction;
a unit for measuring, for each frequency, a property representative of the concentration of at least one of the species under the effect of the periodic variation, capable of determining at least the first-order oscillation amplitudes of the concentration of that species,

characterized in that the device further includes an analysis assembly comprising:
a unit for choosing a reaction presumed reaction mechanism;
a unit for selecting at least one first characteristic function of a thermokinetic property that is invariant with the oscillation frequency for said presumed reaction mechanism, the first characteristic function being calculated at least from first-order oscillation amplitudes of the concentration of at least said species;
a unit for calculating a plurality of values of the first characteristic function from first-order oscillation amplitude measurements obtained experimentally for the plurality of frequencies of the periodic excitation generated using the unit;
a unit for analyzing calculated values of the first characteristic function to determine whether the first characteristic function is constant based on the calculated values;
a unit for assigning the presumed mechanism to said reaction when the first characteristic function is constant.

The device according to the invention may comprise the following feature:
it includes a unit for calculating a thermokinetic constant based on equations representative of that constant for the mechanism assigned by the assigning unit, the representative equations depending on at least the measured first-order amplitudes.

The invention will be better understood upon reading the following description, provided solely as an example, and done in reference to the appended drawings, in which:

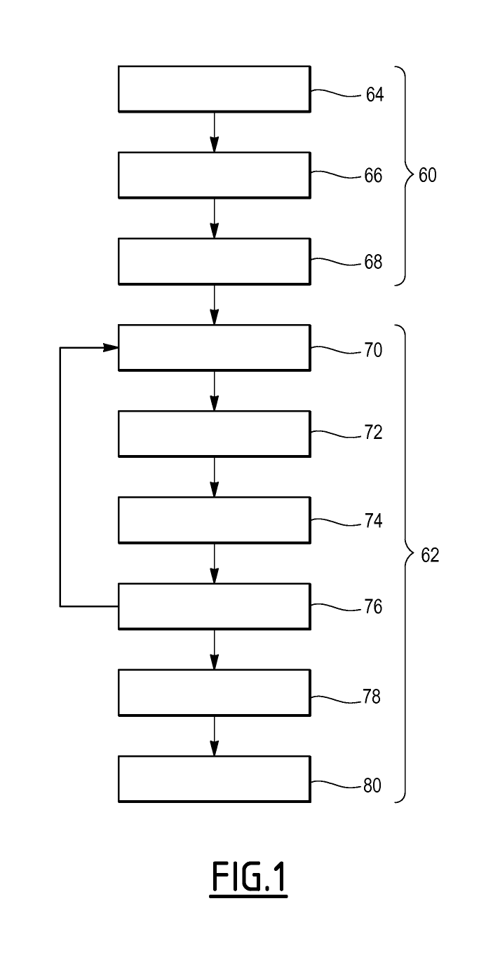

FIG. 1 shows a flowchart describing the main steps of the method according to the invention;

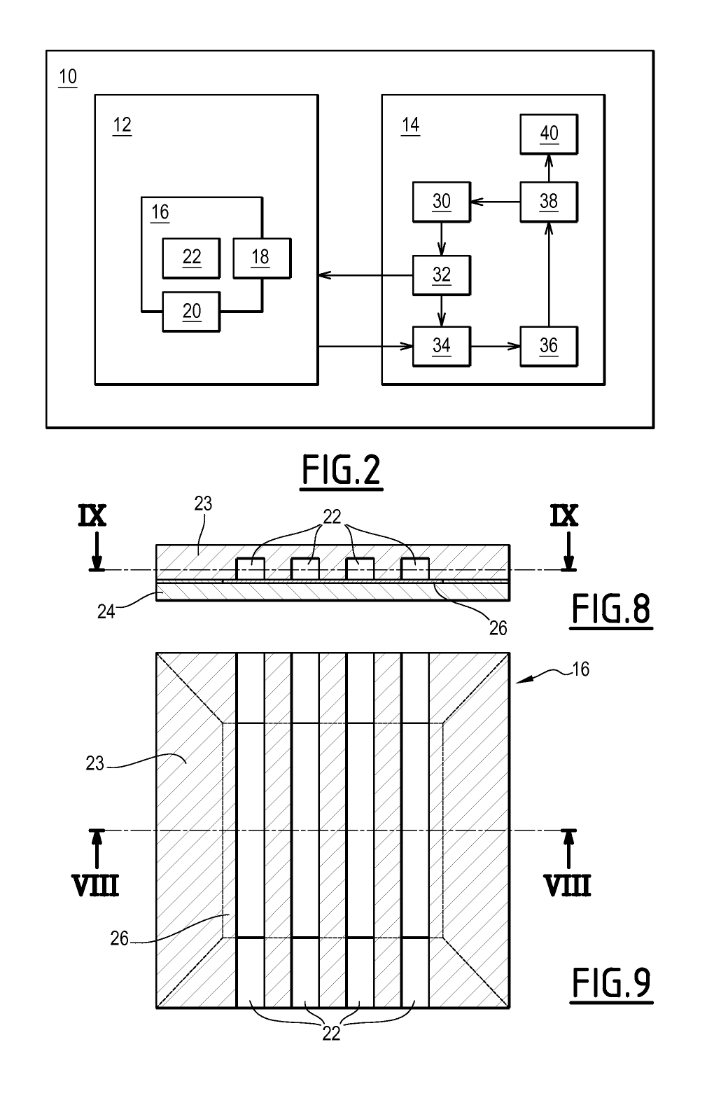

FIG. 2 is a view of a device implementing the inventive method;

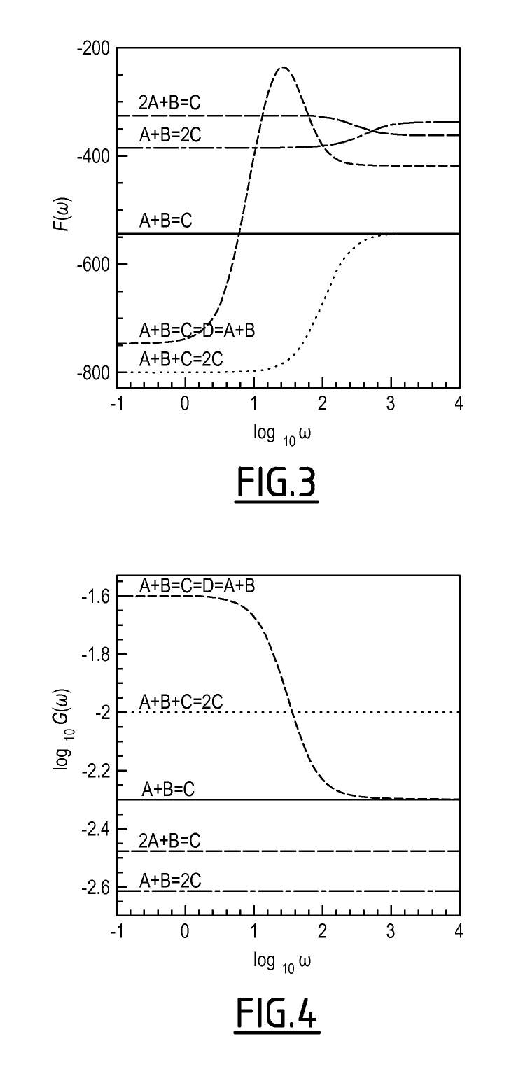

FIG. 3 is a view of the theoretical behavior of a first characteristic function of an invariant thermokinetic property for a first given mechanism A+B=C, the first function being obtained for different presumed reaction mechanisms;

FIG. 4 is a view similar to FIG. 3, for a second characteristic function of a second invariant thermokinetic property for the first mechanism A+B=C, the second function being obtained for different presumed reaction mechanisms;

FIG. 5 is a view similar to FIG. 3 for a third characteristic function of a third invariant thermokinetic property for the first mechanism;

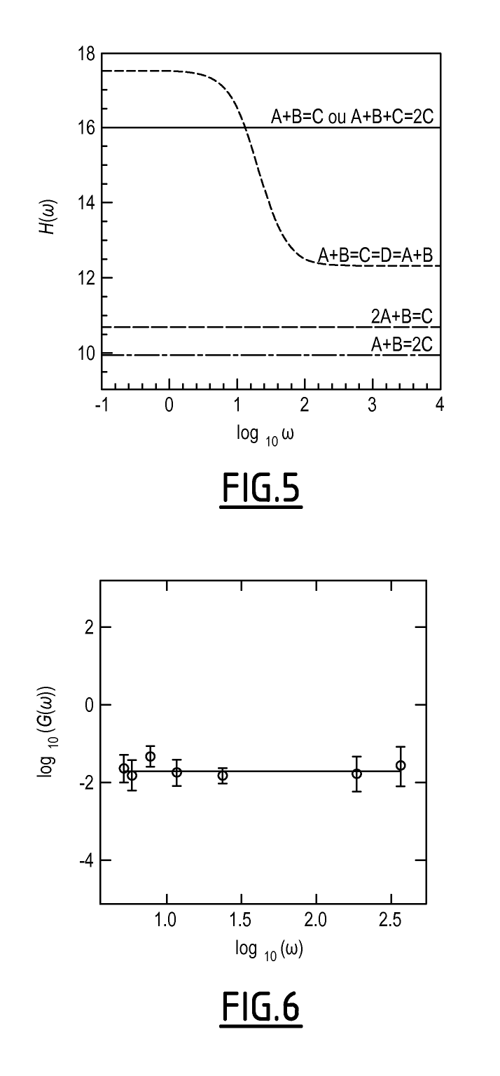

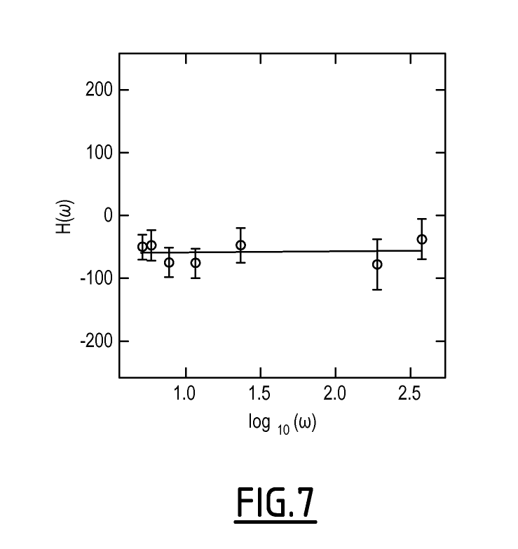

FIGS. 6 to 7 illustrate the experimental determinations of a plurality of values of a characteristic function from oscillation amplitude measurements, here first-order in phase and phase quadrature, obtained experimentally for a plurality of measured frequencies;

FIGS. 8 and 9 are side cross-sectional and top cross-sectional diagrammatic views, respectively, of one example of a reactor making it possible to implement a reaction under conditions comprising a variation of a control parameter influencing the reaction.

The main steps of a determination method according to the invention are illustrated by FIG. 1.

The method according to the invention is designed to determine the reaction mechanism of a reaction in which at least one first reagent A is transformed into at least one first product C, in particular when a second reagent B reacts with A.

The second reagent B is advantageously in excess during the reaction, such that its concentration variation is low. Thus, the concentration of the second reagent is advantageously more than 2 times the concentration of the first reagent A, and is in particular more than 5 times the concentration of the first reagent A.

The species A, B and C may be of any type. They are for example in liquid, gas or solid form, pure or in solution.

The species A, B and C are for example biomolecules (in particular nucleic acids, proteins, drugs, medicaments), reagents resulting from organic, inorganic or mineral synthesis, natural products, metallic complexes, catalysts, nanoparticles, or even adsorption sites at an interface.

The chemical reaction implemented is of the type:

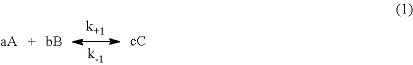

The reaction mechanism between A and B is a priori unknown before implementing the method. The purpose of the inventive method is to determine it. Alternatively, the reaction mechanism between A and B is presumed, and the inventive method is designed to confirm it.

The method according to the invention also aims, once the reaction mechanism is known, to determine the thermokinetic constants of the reaction by calculation, in particular in order to optimize the progression of the reaction or to increase understanding of the chemical or biological phenomena being studied. Furthermore, determining the thermokinetic constants provides an indication as to the feasibility of a reaction and the utility of its implementation in the context of an industrial production, or in the context of the estimation of the therapeutic or catalytic potential of a molecule, in particular in the context of screening a series of molecules.

The method according to the invention is advantageously implemented in a device 10 shown in FIG. 2.

The device 10 includes an assembly 12 for carrying out a reaction between the reagents A, B to form the product C. It includes an assembly 14 for analyzing the results obtained during each reaction carried out in the assembly 12.

As illustrated by FIG. 2, the assembly 12 includes at least one reactor 16 in which the transformation of a first reagent A into a first product C, optionally in the presence of a second reagent B in excess, is carried out under given experimental conditions.

The assembly 12 further includes a unit 18 for periodically varying a control parameter influencing the reaction kinetics, capable of periodically varying the control parameter at a plurality of frequencies.

The assembly 12 also comprises a measuring unit 20 making it possible to measure at least the first-order oscillation amplitudes of a measurement representative of the concentration of a species A, B, C in the reactor 16. Advantageously, the measuring unit 20 is capable of monitoring the periodic variations of a property representative of the concentration of a first reagent A in the reactive medium.

Advantageously, the representative property is proportional to the concentration of the first reagent A in the reactive medium. It is thus possible to monitor the progression of the reaction between A and B using the measuring unit 20.

The reactor 16 includes at least one volume 22 in which the reagents A, B are placed, and in which the product C is obtained.

In the particular example shown in FIG. 8, the reactor 16 includes a plurality of volumes 22 positioned in parallel with each other, to carry out a plurality of parallel reactions on the same species, for example at different oscillation pulses ω, or on different reagents.

The volumes 22 are for example formed by conduits shown diagrammatically in FIG. 9, in which the first reagent A, and the second reagent B when it is present, are placed.

In this example, each volume 22 is for example formed by a matrix 23 made from a plastic material positioned on a support plate 24.

One example of a reaction assembly that can be used is described in the article “Thermal characterization of a microfluidic cell using the 3Ω method” published in the “Digest of the Technical Papers of the 14th International Conference on Solid State Sensors, Actuators and Microsystems”, 2007, pages U933-U934.

In this example, the support plate 24 is transparent to allow an optical measurement on the contents of each volume 22.

Each volume 22 has a size comprised between 1 nm and 100 μm in order to have a volume for example smaller than 1 nL.

More generally, it is necessary for the volume 22 to have a thermal relaxation time shorter than the reverse of the oscillation pulse of the control parameter influencing the reaction.

For example, the reaction volume 22 does not necessarily need to be physically enclosed; it may be made up of a portion of the reaction medium (for example, a liquid ring on the surface of metal colloids heated by microwave or a focal volume in which the light energy provided by a laser is converted into heat).

In another alternative, the volume 22 forms a drop of liquid.

In one advantageous embodiment, the control parameter influencing the reaction is the temperature.

Alternatively, the control parameter influencing the reaction is chosen from among the pressure, concentration of species B or another compound (proton, salt, decharacterizing agent), a flow of particles (photons, ions), a field (electric, magnetic).

In the event the control parameter is the temperature, the periodic variation unit 18 comprises a member 26 for heating the contents of each volume 22 and a module 28 for controlling each heating member 26 to create sinusoidal temperature oscillations of type:

T=T₀·[1+β sin(ωt)] (2)

in the volume 22 around a mean temperature T₀ with heating amplitude β, for a given pulse ω.

The temperature oscillations for example vary from 0.1 K to 1 K, for a frequency range comprised between 10⁻³ Hz and 10⁹ Hz. Heating pulses are advantageously in particular comprised between 5 rad/s and 376 rad/s.

In the example shown in FIGS. 8 and 9, each heating member 26 is formed by a metal conductive or semi-conductive or liquid heating blade through which an electric current is injected.

This blade is for example formed by a layer of transparent and resistive material such as an indium and tin oxide. This layer has been deposited on the substrate 24.

It for example has a thickness smaller than a micrometer, in particular comprised between 200 nm and 600 nm, and is covered by a silica coating to avoid the manifestation of electrochemical reactions.

The heating member 26 is thus capable of causing a uniform thermal excitation on a surface of the chamber 22.

Alternatively, the heating is produced by applying a laser beam, microwave electromagnetic radiation, or by injecting electric current into the reaction medium when it is conductive (thereby causing heating by Joule effect).

The control module 28 includes an electric generator, for example of type 33220A—20 MGHz, marketed by the American company Agilent. The generator is capable of producing a sinusoidal alternating current with a pulse ω/2 equal to half of the desired pulse ω for the temperature.

The measuring unit 20 is capable of measuring the oscillations of a property representative of the concentration of at least one species A, B, C resulting from the periodic variation of the control parameter influencing the reaction, and in particular at least one oscillation of the property representative of the concentration of reagent A.

The unit 20 can also determine the mean value of the property representative of the concentration at the mean temperature T₀, but it is important to note that any other non-periodic alteration of the signal is very difficult to detect. Conversely, the existence of synchronous detection amplifiers makes it relatively easy to characterize responses from the chemical system to the excitation in temperature, amplitude and phase, for the first and second harmonic.

The oscillations of the representative property are next linked to the oscillations of the concentration by calibration. In particular, the representative property is proportional to the concentration.

Advantageously, the unit 20 includes a device for optical detection of the concentration variations of a species A.

In one embodiment, the species A whereof the concentration is monitored is fluorescent at a given wavelength, whereas C is less so. The optical detection device then includes a member emitting a light capable of causing the species to fluoresce and a fluorescence measurement apparatus, such as a fluorescence microscope.

One example of a detection device is described in the article “Temperature modulation and quadrature detection for selective titration of two-state exchanging reactants”, Analytical Chemistry, 2011, pages 2076 to 2484.

Such a device is capable of measuring a property proportional to the concentration of reagent A as a function of time, to deduce the periodic oscillations of the concentration of species A therefrom, as well as the associated stationary term A⁰.

Advantageously, the microscope is provided with a camera capable of measuring and storing, as a function of time and the position in the volume 22, a fluorescence intensity.

The fluorescence intensity oscillations are next linked to the concentration oscillations, through a calibration, as described in the aforementioned article.

Alternatively, other types of measuring units 20 are used for example comprising detectors such as photomultipliers, photodiodes or other optoelectronic components, mechanical resonators, plasmonic, electric or electrochemical sensors.

The property detected by the measuring unit 20 is therefore advantageously chosen in particular from among the fluorescence, mass, refraction index, intensity of a vibrational line, absorbance, etc. This property is measured by a suitable detector present in the measuring unit.

The analysis assembly 14 is connected to the measuring unit 20. It is for example formed by a unit including a calculator and a memory, such as a computer.

It includes a unit 30 for choosing a reaction presumed reaction mechanism from among a plurality of presumed reaction mechanisms, a unit 32 responsible for selecting at least one function characteristic of a thermokinetic property that is invariant with the oscillation frequency for the reaction mechanism presumed by the unit 30 and responsible for having the reaction carried out by the unit 12, a unit 34 for calculating a plurality of values of the characteristic function from first-order oscillation amplitudes, and optionally second-order oscillation amplitudes, obtained experimentally in the assembly 12 for conducting a reaction.

The analysis assembly 14 further includes a unit 36 for analyzing calculated values of the characteristic function to determine whether that function is constant, and a unit 38 for assigning the presumed mechanism to the reaction when the characteristic function is constant and redirecting toward the search for an alternative mechanism when the function is not constant.

The analysis summary 14 further includes a unit 40 for calculating at least one thermokinetic constant based on the reaction mechanism assigned by the unit 38.

The unit 30 includes a database containing different possible reaction mechanisms such as the following mechanisms:

A+B=C, A+B=2 C, 2A+B=C, A+B+C=2C, A+B=C=D=A+B, etc.

For each mechanism present in the database of the unit 30, the unit 32 includes a database of characteristic functions of a thermokinetic property that is invariant with the oscillation frequency of the property influencing the reaction.

In the rest of this text, these representative functions are denoted F(ω), G(ω), H(ω). They will be described in more detail below. It is, however, important to note that they differ from the functions traditionally traced, for example the amplitude and the phase of the first-order oscillations (Bode diagram), inasmuch as the constant value makes it possible, if the presumed mechanism is validated, to obtain the characteristic thermokinetic property without digital adjustment.

The invariant thermokinetic property may be an activation energy E±₁ of the reaction or its reduced form:

ε_{±}1=E±₁/RT₀ (3),
where R is the perfect gas constant and T₀ is the temperature, or a formula linking the activation energies or the reduced forms to each other.

In one embodiment, a first characteristic function F(ω) corresponds to the thermokinetic property:

ε₋₁·(ε₋₁−2)−ε₊₁·(ε₊₁−2) (4).

A second characteristic function G(ω) corresponds to the thermokinetic property which is the relaxation time of the reaction.

A third characteristic function H(ω) corresponds to the thermokinetic property:

$$\frac{d A}{d t} = U \cdot A + V \qquad ( 6 )$$

where Δ₁H is the reaction enthalpy.

Each presumed reaction mechanism present in the database of the unit 30 has at least one, advantageously at least three, corresponding representative functions F(ω), G(ω), H(ω) in the database of the unit 32, the expression of which depends on the presumed reaction mechanism.

Each characteristic function F(ω), G(ω), H(ω) present in the database of the unit 32 is expressed as a function of at least one parameter chosen from among the stationary term A⁰ of the concentration oscillations of a species A, the coefficients A^{1 sin}, A^{1 cos}, and optionally the coefficients A^{2 sin}, A^{2 cos} which respectively correspond to the amplitudes of the first-order and second-order oscillations of the concentration of the species A, at the pulse ω, in phase and in phase quadrature, respectively.

Each characteristic function F(ω), G(ω), H(ω) is furthermore advantageously expressed as a function of the pulse ω, and/or the value N of the concentration in the species A before the beginning of the reaction.

The representative functions F(ω), G(ω), H(ω) are obtained using the following method, illustrated for the mechanism A+B=C.

For each given mechanism, the equation of the chemical kinetics of the presumed reaction mechanism is established.

In the case of the aforementioned mechanism A+B=C, with an excess of the second reagent B, this equation is written:

$$\frac{{Δ}_{1} H}{R \cdot {T}_{0}} , \qquad ( 5 )$$

where

U=−[k₊₁B+k₋₁] (7)

and

V=k₋₁·N (8),

where N is equal to the quantity of reagent A introduced into the volume 22.

Then, a material conservation equation is used to obtain the concentration of the produced species C:

C=N−A (9)

Next, a second-order limited development of the concentration of species A is done to obtain:

A=A⁰+βA¹+β²A² (10)

where:

A¹=A^{1 sin}·sin(ωt)+A^{1 cos}·cos(ωt)

A²=A^{2 sin}·sin(2ωt)+A^{2 cos}·cos(2ωt) (11)

Likewise, the coefficients U and V can be developed to the second order to obtain:

U=U⁰+βU¹+β²U² (12)

V=V⁰+βV¹+β²V² (13)

The kinetic constants are also developed to the second order to obtain:

k_{±1}=k_{±1}⁰+βk_{±1}¹+β²k_{±1}² (13bis), where

k_{±1}⁰=r_{±1}exp(−ε_{±1}), k_{±1}¹=k_{±1}⁰ε_{±1} sin(ωt) (13ter)

k_{±1}²=k_{±1}⁰[ε_{±1}(ε_{±1}−2)]×[1−cos(2ωt)]/4 (13quater)

in which r_{±1} defines the constant pre-exponential factor appearing in the Arrhenius law.

Then, the differential equation is resolved to different orders to express the coefficients A⁰, A^{1 sin}, A^{1 cos}, A^{2 sin}, A^{2 cos} as a function of the kinetic constants.

At order 0, one obtains:

$$\begin{matrix}{A}^{0} = \frac{{k}_{- 1}^{0} \cdot N}{{k}_{+ 1}^{0} \cdot B + {k}_{- 1}^{0}} & ( 14 ) \\ {C}^{0} = N - {A}^{0} & ( 15 )\end{matrix}$$

At order 1, resolving the differential equation makes it possible to calculate coefficients A^{1 sin} and A^{1 cos} to obtain:

$$\begin{matrix}{A}^{1 sin} = - \frac{{k}_{+ 1}^{0} \cdot B \cdot {k}_{- 1}^{0} \cdot N}{{( {k}_{+ 1}^{0} \cdot B + {k}_{- 1}^{0} )}^{2} + {ω}^{2}} \cdot \frac{{Δ}_{1} H}{R \cdot {T}_{0}} & ( 16 ) \\ {A}^{1 cos} = - \frac{ω}{{k}_{+ 1}^{0} \cdot B + {k}_{- 1}^{0}} \cdot {A}^{1 sin} & ( 17 )\end{matrix}$$

At order 2, resolving the differential equation yields:

$$\begin{matrix}{A}^{2 sin} = \frac{( {k}_{+ 1}^{0} \cdot B \cdot {ɛ}_{+ 1} + {k}_{- 1}^{0} \cdot {ɛ}_{- 1} ) \cdot ( 2 ω \cdot {A}^{1 sin} - ( {k}_{+ 1}^{0} \cdot B + {k}_{- 1}^{0} ) \cdot {A}^{1 cos} )}{2 \cdot ( {( 2 ω )}^{2} + {( {k}_{+ 1}^{0} \cdot B + {k}_{- 1}^{0} )}^{2} )} - \frac{ω \cdot {k}_{+ 1}^{0} \cdot B \cdot {A}^{0} \cdot ( {ɛ}_{- 1} \cdot ( {ɛ}_{- 1} - 2 ) - {ɛ}_{+ 1} \cdot ( {ɛ}_{+ 1} - 2 ) )}{2 \cdot ( {( 2 ω )}^{2} + {( {k}_{+ 1}^{0} \cdot B + {k}_{- 1}^{0} )}^{2} )} & ( 18 ) \\ {A}^{2 cos} = \frac{{k}_{+ 1}^{0} \cdot B + {k}_{- 1}^{0}}{2 ω} \cdot {A}^{2 sin} + \frac{{k}_{+ 1}^{0} \cdot B {ɛ}_{+ 1} + {k}_{- 1}^{0} \cdot {ɛ}_{- 1}}{4 ω} \cdot {A}^{1 cos} & ( 19 )\end{matrix}$$

A term not dependent on the time may also be found, but its contribution to the mean value of the oscillations being weighted by a coefficient β², it is negligible faced with A⁰.

The obtained formulas (14) to (19) are directly used to obtain:

$$\begin{matrix}{k}_{+ 1}^{0} \cdot B = - ω \frac{N - {A}^{0}}{N} \frac{{A}^{1 sin}}{{A}^{1 cos}} & ( 20 ) \\ {k}_{- 1}^{0} = - ω \frac{{A}^{0}}{N} \frac{{A}^{1 sin}}{{A}^{1 cos}} & ( 21 ) \\ \frac{{Δ}_{1} H}{R \cdot {T}_{0}} = - \frac{{NA}^{1 sin}}{{A}^{0} ( N - {A}^{0} )} ( 1 + {( \frac{{A}^{1 cos}}{{A}^{1 sin}} )}^{2} ) & ( 22 )\end{matrix}$$

Formula (22) corresponds to the definition of the third characteristic function H(ω). The second characteristic function G(ω) is deduced from the preceding equations using the expression:

$$\begin{matrix}{τ}_{1} = \frac{1}{{k}_{+ 1} B + {k}_{- 1}} \\ = - \frac{{A}^{1 cos}}{ω \cdot {A}^{1 sin}}\end{matrix} \qquad ( 23 )$$

The first characteristic function F(ω) is obtained by the following formula, in particular from equations (18) and (19):

$${ɛ}_{- 1} \cdot ( {ɛ}_{- 1} - 2 ) - {ɛ}_{+ 1} \cdot ( {ɛ}_{+ 1} - 2 ) = \frac{4 N}{{A}^{0} \cdot ( N - {A}^{0} )} \cdot ( {A}^{2 sin} \cdot ( \frac{2 {A}^{1 cos}}{{A}^{1 sin}} - \frac{{A}^{1 sin}}{{A}^{1 cos}} ) - 3 {A}^{2 cos} ) \qquad ( 24 )$$

The same approach can be implemented to obtain the representative functions F(ω), G(ω), H(ω) associated with the other presumed mechanisms A+B=2 C, 2A+B=C, A+B+C=2C, A+B=C=D=A+B, etc.

At least one characteristic function F(ω), G(ω), H(ω) expressed as a function of the aforementioned parameters A⁰, A^{1 sin}, A^{1 cos}, A^{2 sin}, A^{2 cos}, N, ω is therefore associated with each presumed reaction mechanism to characterize that mechanism.

A first method according to the invention, for determining the reaction mechanism of a reaction, will now be described in light of FIG. 1.

This method includes an experimentation phase 60, carried out in the implementing assembly 12, and an analysis phase 62, conducted in the analysis assembly 14 based on data measured during the experimentation phase 60.

Thus, in the experimentation phase 60, the method includes a step 64 for carrying out a reaction transforming reagents A and B into a product C under different experimental conditions, in which a control parameter influencing the reaction is varied periodically at a given frequency (corresponding to a pulse ω), and a step 66 for scanning a plurality of given frequencies of the periodic variation.

The method further comprises a step 68 for measuring, for each given frequency, at least the first-order oscillation amplitudes, in phase and phase quadrature, of the property representative of the concentration of at least one of the species A, B, C. This then makes it possible to obtain at least the amplitudes A^{1 sin}, A^{1 cos} of the response of the chemical system to the periodic excitation.

The analysis phase 62 includes a step 70 for choosing a reaction presumed reaction mechanism, from among a plurality of presumed reaction mechanisms, a step 72 for selecting at least one characteristic function of a thermokinetic property that is invariant with the oscillation frequency for the selected mechanism, then a step 74 for calculating a plurality of values of the selected function from experimental measurements done on the periodic response of the chemical system to a periodic excitation applied to a plurality of frequencies.

The method next includes a step 76 for analyzing the calculated values to determine whether the function is constant.

If the function is constant, the method includes a step 78 for assigning the presumed mechanism to the reaction carried out experimentally, and advantageously, a step 80 for calculating thermokinetic constants based on the reaction mechanism assigned to the reaction.

In the event the function is not constant, the method for identifying the mechanism returns to step 70, where a new presumed reaction mechanism is selected and the entire test procedure is carried out.

Initially, during step 64, the chemical reaction is implemented under given experimental conditions. These experimental conditions include a starting concentration of a first reagent A, the potential addition of a second reagent B in excess relative to the first reagent A, and the determination of a mean temperature T₀ around which temperature oscillations will be imposed.

“In excess” means that the concentration of the second reagent is higher than that of the first reagent A and is in particular more than 2 times, in particular more than 3 times, higher than that of the reagent A.

The first reagent A and the second reagent B, when it is present, are introduced into a volume 22, then a time modulation of the control parameter influencing the reaction at a given frequency corresponding to a pulse ω is done.

Advantageously, the control parameter influencing the reaction is the temperature. The temperature of the reaction volume 22 is therefore modulated around the temperature T₀ at the pulse ω created according to the following equation:

T=T₀·[1+β sin(ωt)] (2)

This time modulation of the temperature is controlled by the unit 18, and is for example created by the heating members 26.

In step 66, a plurality of variation frequencies of the oscillation frequency of the control parameter influencing the reaction are scanned either in series or in parallel.

The scanned frequencies, expressed in terms of pulse, for example vary between 5 rad/s and 376 rad/s.

The number of scanned frequencies is greater than 2, in particular greater than at least 5, or even at least 10, for example comprised between 2 and 100. The higher the number of points is, the greater the precision obtained will be on the determination of the thermostatic constant done by the unit 40.

The measurements must be done on an interval such that the explored pulses cover at least two logarithmic units (log₁₀). Additionally, this interval must be centered around the inverse of the presumed chemical relaxation time for the studied reaction. The interval in question may be set after an evaluation of τ₁ for example based on the tracing of the Bode diagrams.

Alternatively, the excitation may be done by the unit 18 simultaneously with several pulses ω, owing to a function generator. The analysis of the signal provided by the unit 20 may also be done in parallel, in particular by Fourier analysis. The term “scanning” therefore does not necessarily imply the idea of an experimental protocol conducted serially.

For each frequency, the transformation reaction defined in step 64 is conducted under the same external conditions, with the same mean temperature T₀, advantageously the same variation amplitude β, the only variable being the pulse ω.

Alternatively, the variation amplitude β changes from one measurement to the next. However, the measured amplitudes are corrected as a function of the relative value of β between the different measurements done at different frequencies.

In step 68, the oscillations of the property representative of the concentration of at least one species A, B, C, and in particular the first reagent A, are measured for each given frequency.

In particular, if β is less than approximately 10⁻², and if βT₀ is advantageously of the order of degree K, the concentration oscillations of the first species A can be developed to the second order using the equation

A=A⁰+β└A^{1 sin}·sin(ωt)+A^{1 cos}·cos(ωt)┘+β²└A^{2 sin}·sin(2ωt)+A^{2 cos}·cos(2ωt)┘ (24)

In step 68, the unit 20 therefore measures the oscillations of the representative property of the concentration of the species A for each oscillation frequency, and determines at least the coefficients A^{1 sin}, A^{1 cos}, and optionally the coefficients A^{2 sin}, A^{2 cos} that correspond to the amplitudes of the first-order and second-order oscillations, respectively, of the concentration of the species A.

This determination is for example done using the optical methods described in the article by Zrelli et al. cited above, based on the measured optical signal.

Steps 66 and 68 are reproduced for different pulse frequencies, for example comprised in a pulse range between 5 rad/s and 376 rad/s. Thus, it is possible to obtain the stationary term A⁰ for each pulse ω, as well as the different amplitudes A^{i sin} and A^{i cos} for i=1 and optionally for i=2.

Once these data are collected by the implementing assembly 12, during the phase 60, the analysis phase 62 in the device 14 is started.

This phase initially includes a step 60 for choosing a presumed reaction mechanism for the reaction in question. Advantageously, the presumed mechanism is a mechanism of type A+B=C.

Alternatively, other mechanisms comprised in the storage unit 30 of the mechanisms can be considered, like those described above.

Then, in step 72, at least one characteristic function F(ω), G(ω), H(ω) of a thermokinetic property that is invariant with the oscillation frequency for that presumed mechanism is selected.

Advantageously, the invariant thermokinetic property of the first characteristic function F(ω) for example depends on the activation energy E±₁ of the reaction or its reduced form:

ε_{±1}=E±₁/RT₀ (3)

or an expression linking the activation energies to each other, such as:

ε₋₁·(ε₋₁−2)−ε₊₁·(ε₊₁−2) (4).

Thus, a first characteristic function F(ω) of a thermokinetic property is calculated as previously described. According to the mechanism A+B=C, the function F(ω) is written in the form:

$$F ( ω ) = \frac{4 N}{{A}^{0} \cdot ( N - {A}^{0} )} \cdot ( {A}^{2 sin} ( \frac{2 {A}^{1 cos}}{{A}^{1 sin}} - \frac{{A}^{1 sin}}{{A}^{1 cos}} ) - 3 {A}^{2 cos} ) , \qquad ( 25 )$$

where N is the initial concentration of reagent A and the other terms are first-order and second-order oscillation amplitudes of the concentration of species A, in phase and phase quadrature.

This function F(ω) is representative of a thermokinetic property that is invariant with the oscillation frequency for the mechanism A+B=C, as illustrated by the theoretical depiction of FIG. 3.

On the contrary, for other mechanisms such as the mechanisms A+B=2C, 2A+B=C, A+B=C=D=A+B or A+B+C=2C, the function F(ω) as defined by equation (25) is not representative of a thermokinetic property that is invariant with the frequency and varies as a function of the frequency.

Advantageously, at least one second characteristic function G(ω) is calculated, for example from a thermokinetic property that is invariant with the oscillation frequency formed by the relaxation time τ₁.

As previously described for the mechanism A+B=C, the function G(ω) then assumes the form:

$$G ( ω ) = - \frac{{A}^{1 cos}}{ω \cdot {A}^{1 sin}} . \qquad ( 26 )$$

As shown in FIG. 3, the function G(ω) is theoretically constant for certain reaction mechanisms (A+B=C, A+B+C=2C, 2A+B=C, A+B=2C), whereas it varies for other reaction mechanisms (A+B+C=C=D=A+B).

Also advantageously, a third characteristic function H(ω) of a thermokinetic property that is invariant with the oscillation frequency for the present reaction mechanism is selected, based on the ratio between the reaction enthalpy Δ₁H and the product R·T₀ of the perfect gas constant R by the mean temperature T₀.

According to the mechanism A+B=C, this function H(ω) is written as follows:

$$H ( ω ) = - \frac{{NA}^{1 sin}}{{A}^{0} ( N - {A}^{0} )} ( 1 + {( \frac{{A}^{1 cos}}{{A}^{1 sin}} )}^{2} ) \qquad ( 27 )$$

As shown in FIG. 5, the function H(ω) is theoretically constant for different mechanisms (A+B=2C, 2A+B=C, A+B+C=2C), whereas it is not for the mechanism A+B=C=D=A+B.

In step 74, the measurements of the stationary term A⁰ and oscillation amplitudes A^{1 sin}, A^{1 cos}, A^{2 sin}, A^{2 cos} determined experimentally to the first order, and optionally to the second order, are used to calculate a plurality of values of each characteristic function selected in step 72 at the plurality of measured frequencies of periodic variations of the property influencing the reaction.

Thus, for each frequency measured experimentally, the values of the coefficients A⁰, A^{1 sin}, A^{1 cos}, A^{2 sin}, A^{2 cos} determined experimentally for that frequency are introduced into equations (25) to (27) above. This makes it possible to calculate a value of the characteristic function F(ω), G(ω) and H(ω) associated with each frequency.

A plurality of values of each function F(ω), G(ω) and H(ω) is calculated from first-order and optionally second-order oscillation amplitude measurements obtained experimentally, for a plurality of frequencies.

Examples of experimental value curves of the functions G(ω) and H(ω) are provided in FIGS. 6 and 7.

Then, in step 74, the calculated values of each function F(ω), G(ω) and H(ω) are analyzed to determine whether the function F(ω), G(ω) or H(ω) is constant.

For example, the corrected empirical standard deviation calculated from the plurality of values of the function must be below the mean of the experimental uncertainties on the values of the function, measured or estimated, for each of the pulses.

Thus, the value of the characteristic function F, G, H is determined at each measuring frequency, and a set of n values F(ωᵢ), G(ωᵢ), H(ωᵢ) is obtained. The uncertainty on each value is measured or estimated; a set of σ_{F}(ωᵢ), σ_{G}(ωᵢ), σ_{H}(ωᵢ) is obtained.

Then, the mean of the values of the characteristic function obtained for the different frequencies is calculated: <F>=1/nΣᵢF(ωᵢ), <G>=1/nΣᵢG(ωᵢ), <H>=1/nΣᵢH(ωᵢ). This then makes it possible to determine the corrected empirical standard deviation for the set of data made up of the values of the function on the plurality of frequencies at which the measurements were done: E_{F}=√(1/(n−1)Σᵢ[F(ωᵢ)−<F>]²), E_{G}=√(1/(n−1)Σᵢ[G(ωᵢ)−<G>]²), E_{H}=√(1/(n−1)Σᵢ[H(ωᵢ)−<H>]²).

Lastly, the mean of the uncertainties is calculated: <σ_{F}>=1/nΣᵢσ_{F}(ωᵢ), <σ_{G}>=1/nΣᵢσ_{G}(ωᵢ), <σ_{H}>=1/nΣᵢσ_{H}(ωᵢ).

For the function to be declared constant, it suffices for E_{F}≦<σ_{F}>, E_{G}≦<σ_{G}>, E_{H}≦<σ_{H}>.

In another specific example, the function F(ω), G(ω), or H(ω) is considered to be constant, if the corrected empirical standard deviation of the values determined for the function is below a given threshold, for example below 30% of the mean.

In step 78, if each characteristic function F (ω), G(ω), H(ω) presumed to be constant for the given mechanism is considered to be constant in step 74, the presumed mechanism is assigned to the reaction.

In particular, when the function F(ω) is constant after step 76, the reaction mechanism A+B=C is assigned to the reaction, since that mechanism is the only one that can yield a constant value of F(ω).

When a mechanism is assigned to the reaction, the functions G(ω) and H(ω) can confirm the assignment of the mechanism in question.

On the contrary, if a function F(ω) presumed to be constant for the presumed mechanism is not constant after step 76, the method may comprise a return to step 70 in order to choose another reaction presumed reaction mechanism, and select new expressions of functions representative of thermokinetic properties that are invariant with the oscillation frequency for that new presumed reaction mechanism.

Step 74 is then repeated to determine whether the new characteristic functions are indeed constant.

In one alternative, when the characteristic function G(ω), H(ω) does not make it possible to discriminate between several presumed mechanisms, the assignment step may comprise a step in which particular values of a secondary characteristic function I(ω) that is not constant for that mechanism are calculated, to determine a criterion discriminating between several representative functions based on the calculation.

In particular, when the characteristic function F(ω) is not constant but the functions G(ω) and H(ω) are constant, the mechanism may be of type A+B=2C, 2A+B=C, or A+B+C=2C. The function I(ω) is for example calculated as the difference between the value F(ω) at a pulseω>>1/τ₁ and the asymptotic value F(0) at zero frequency.

If that difference is negative, the mechanism 2A+B=C can be assigned, whereas if that difference is positive, a choice must be made between the mechanism A+B=2C and the mechanism A+B+C=2C.

Once the external mechanism is assigned in step 78, the calculating step 80 is carried out.

This step allows a direct calculation, from experimental oscillation amplitudes A^{1 sin}, A^{1 cos}, A^{2 sin}, A^{2 cos}, of the thermokinetic properties such as the activation energies and E₋₁, respectively associated with the formation and dissociation of the product, the reaction enthalpy Δ₁H and the relaxation time τ₁.

For example, for the mechanism A+B=C, the different constants can be calculated by equations (22) to (24) previously cited.

It is thus possible to perform a simple and precise estimate of the thermokinetic parameters. Such a determination in particular makes it possible to optimize the reaction methods, or to screen molecules that may have an interesting activity, for example of the therapeutic or catalytic type.

The method according to the invention may advantageously be implemented with small quantities of reagent, which decreases its cost. Furthermore, a single sample is necessary for the variation of the modulation frequency, which simplifies the method.

In one particular embodiment, the unit 14 includes a display means (not shown) for displaying the determined reaction mechanism, as well as the calculated thermokinetic properties.

1. A method for determining the reaction mechanism of a reaction, in which at least one first reagent is transformed into at least one first product, the process including the following steps:
(a1) carrying out a reaction to transform the first reagent into a first product under given experimental conditions, the reaction comprising the periodic variation at a given frequency of a control parameter influencing the reaction;
(a2) scanning a plurality of given frequencies of periodic variations of the control parameter influencing the reaction; and
(a3) for each studied frequency, measuring a property representative of the concentration of at least one of the species under the effect of the periodic variation, to determine at least the first-order oscillation amplitudes of the concentration,
the method further comprising the following steps:
(a4) choosing a reaction presumed reaction mechanism;
(a5) selecting at least one first function characteristic of a thermokinetic property that is invariant with the oscillation frequency for said supposed reaction mechanism, the first characteristic function (F(ω)) being calculated at least from first-order oscillation amplitudes of the concentration of at least said species;
(a6) calculating a plurality of values of the first characteristic function from first-order oscillation amplitudes obtained experimentally for the plurality of frequencies of the periodic excitation described in the step (a2);
(a7) analyzing the calculated values of the first characteristic function to determine whether the first characteristic function is constant based on the calculated values; and
(a8) when the first characteristic function is constant, assigning the presumed mechanism to said reaction.

2. The method according to claim 1, wherein the control parameter influencing the reaction is the temperature, step (a1) including the periodic variation of the temperature at the given frequency, step (a2) including the scanning of a plurality of temperature variation frequencies.

3. The method according to claim 1, wherein for each frequency, it includes determining second-order oscillation amplitudes of the concentration in at least one of the species, the first characteristic function selected in step (a5) being calculated based on first-order oscillation amplitudes, and based on second-order oscillation amplitudes.

4. The method according to claim 1, wherein the first characteristic function is calculated based on a reduced form of the ratio of the activation energies to the perfect gas constant multiplied by the mean temperature of the sample.

5. The method according to claim 1, including selecting at least one second characteristic function of a second thermokinetic property that is invariant with the oscillation frequency for said presumed mechanism, the second characteristic function being calculated from at least the first-order oscillation amplitudes of the concentration of at least said species, the method including determining a plurality of values of said second characteristic function from first-order oscillation amplitude measurements obtained in step (a3) for a plurality of frequencies of the periodic excitation and the analysis of calculated values of the second characteristic function to determine whether the second characteristic function is constant.

6. The method according to claim 1, wherein the second characteristic function is calculated based on the relaxation time of the presumed reaction mechanism.

7. The method according to claim 1, wherein the second characteristic function is calculated on the basis of the reaction enthalpy of the presumed reaction mechanism.

8. The method according to claim 1, including selecting a non-constant secondary characteristic function for the presumed reaction mechanism, the secondary characteristic function having a constant sign irrespective of the oscillation frequency for the presumed reaction mechanism, the method including the determination of a plurality of values of the secondary characteristic function from first-order oscillation amplitude measurements obtained in step (a3), and analyzing the sign of those values to determine whether the sign is constant.

9. The method according to claim 1, wherein the first characteristic function is expressed on the basis of at least one parameter chosen from among the stationary term A⁰ of the concentration variations in a species A, the coefficients A^{1 sin}, A^{1 cos}, and optionally the coefficients A^{2 sin}, A^{2 cos} that correspond to the first-order and second-order oscillation amplitudes, respectively, of the concentration of that species A, the pulse ω, and/or the value N of the concentration of that species A before the beginning of the reaction.

10. The method according to claim 1, wherein the presumed mechanism is chosen from among a mechanism of type A+B=C; A+B=2 C; 2A+B=C; A+B+C=2C; A+B=CD=A+B.

11. The method according to claim 1, including a step for calculating at least one thermokinetic constant, based on equations representative of that constant for the mechanism assigned in step (a8), the representative equations depending at least on the measured first-order amplitudes.

12. The method according to claim 1, wherein when the first characteristic function is not constant in step (a7), the method includes the choice of another reaction presumed reaction mechanism and the repetition of steps (a5) to (a8) for the other presumed reaction mechanism.

13. A device for determining the reaction mechanism of a reaction, in which at least one first reagent is transformed into at least one first product, including:
an assembly for carrying out a reaction to transform the first reagent into a first product under given experimental conditions, the carrying out assembly comprising a unit for periodic variation of a control parameter influencing the reaction at a given frequency;
a unit for scanning a plurality of given frequencies of periodic variations of the control parameter influencing the reaction; and
a unit for measuring, for each frequency, a property representative of the concentration of at least one of the species under the effect of the periodic variation, capable of determining at least the first-order oscillation amplitudes of the concentration of that species,
an analysis assembly comprising:
a unit for choosing a reaction presumed reaction mechanism;
a unit for selecting at least one first function characteristic of a thermokinetic property that is invariant with the oscillation frequency for said supposed reaction mechanism, the first characteristic function being calculated at least from first-order oscillation amplitudes of the concentration of at least said species;
a unit for calculating a plurality of values of the first characteristic function from first-order oscillation amplitude measurements obtained experimentally for the plurality of frequencies of the periodic excitation generated using the unit;
a unit for analyzing calculated values of the first characteristic function to determine whether the first characteristic function is constant based on the calculated values; and
a unit for assigning the presumed mechanism to said reaction when the first characteristic function is constant.

14. The device according to claim 13, including a unit for calculating a thermokinetic constant based on equations representative of that constant for the mechanism assigned by the assigning unit, the representative equations depending on at least the measured first-order amplitudes.
